(19) United States
(12) Patent Application Publication
(10) Pub. No.: US 2022/0311008 A1
(43) Pub. Date: Sep. 29, 2022

(54) LITHIUM ION SECONDARY BATTERY

(71) Applicant: TDK CORPORATION, Tokyo (JP)

(72) Inventors: Tomohiko HASEGAWA, Tokyo (JP); Kosuke SATO, Tokyo (JP); Hiroki KARISYUKU, Tokyo (JP); Tomohide SHIRANE, Tokyo (JP); Takashi MORI, Tokyo (JP)

(73) Assignee: TDK CORPORATION, Tokyo (JP)

(21) Appl. No.: 17/703,345

(22) Filed: Mar. 24, 2022

(30) Foreign Application Priority Data
Mar. 26, 2021 (JP) 2021-052994

(51) Int. Cl. H01M 4/62; H01M 4/131; H01M 4/525; H01M 10/0525; H01M 4/505; H01M 4/485

(52) U.S. Cl. CPC H01M 4/628; H01M 4/131; H01M 4/525; H01M 10/0525; H01M 4/505; H01M 4/485; H01M 2004/028

(57) ABSTRACT

The lithium ion secondary battery includes: a positive electrode; a negative electrode; a separator disposed between the positive electrode and the negative electrode; and an electrolytic solution, in which the positive electrode has a metal foil and a positive electrode active material layer provided on the metal foil, a plurality of voids are formed on the positive electrode active material layer, and a transition metal oxide having an average particle size of 10 nm or more and 500 nm or less is provided on an inner wall portion of the voids, on which the voids and the electrolytic solution are in contact with each other.

Priority is claimed on Japanese Patent Application No. 2021-052994 filed on Mar. 26, 2021, the content of which is incorporated herein by reference.

### BACKGROUND OF THE INVENTION

### Field of the Invention

The present invention relates to a lithium ion secondary battery.

### Description of Related Art

Lithium ion secondary batteries, which are characterized by their small size and large capacity, have been installed not only in electronic devices such as mobile phones or notebook computers, but also in moving bodies such as automobiles and drones in recent years, and the applications thereof are expanding more and more.

Since it is necessary to supply electric power to a motor or the like in the above-mentioned moving body, the lithium ion secondary battery installed therein is also required to have better input/output characteristics (rate characteristics) than those of conventional applications. Therefore, various technologies such as improving the active material (Patent Document 1), the electrode structure (Patent Document 2), and the electrolytic solution (Patent Document 3) have been reported in order to improve the rate characteristics.

### PATENT DOCUMENTS

[Patent Document 1] Japanese Unexamined Patent Application, First Publication No. 2017-84628
[Patent Document 2] Japanese Unexamined Patent Application, First Publication No. 2011-204571
[Patent Document 3] Japanese Unexamined Patent Application, First Publication No. 2018-125313

### SUMMARY OF THE INVENTION

However, these characteristics are not sufficient according to the above-mentioned methods of the related art, and further improvement of the rate characteristics is required.

An object of the present invention is to provide a lithium ion secondary battery having excellent rate characteristics.

In order to solve the problems, there is provided a lithium ion secondary battery according to the present invention including: a positive electrode; a negative electrode; a separator disposed between the positive electrode and the negative electrode; and an electrolytic solution, in which the positive electrode has a metal foil and a positive electrode active material layer provided on the metal foil, a plurality of voids are formed on the positive electrode active material layer, and a transition metal oxide having an average particle size of 10 nm or more and 500 nm or less is provided on an inner wall portion of the voids.

It is generally known that, when forming voids in the active material layer, the permeability with respect to the electrolytic solution is improved, and the diffusibility of lithium ions is improved. In addition, by supporting nanoparticles of a transition metal oxide on the inner wall portion of a void, the wettability to the electrolytic solution is improved by the surface tension effect, and the affinity for the electrolytic solution is also improved by the large polarization of the transition metal oxide, and it becomes easier for the electrolytic solution to penetrate in the depth direction of the active material layer. As a result, the rate characteristics are improved.

In the lithium ion secondary battery according to the present invention, the average diameter of the voids is preferably 1.0 μm or more and 10.0 μm or less.

When the voids are extremely small, the permeability with respect to the electrolytic solution will not be improved, and when the voids are extremely large, the capacity per unit area of the electrode will decrease, and the resistance will increase. When an average diameter is within the above-described range, it is suitable as an average diameter for the voids, and it is possible to improve the rate characteristics while maintaining other battery characteristics.

In the lithium ion secondary battery according to the present invention, the transition metal oxide preferably contains one or more transition metals selected from Co, Mn, and Ni.

In the lithium ion secondary battery according to the present invention, at least a part of the transition metal oxide is preferably coated with carbon nanotubes.

According to this, by coating the transition metal oxide with carbon nanotubes having a high aspect ratio and low conductivity, it is possible to suppress the conductive path disruption that tends to occur with the formation of voids, and it is possible to further improve the rate characteristics.

According to the present invention, it is possible to provide a lithium ion secondary battery having excellent rate characteristics.

### BRIEF DESCRIPTION OF THE DRAWINGS

FIG. 1 is a schematic sectional view of a positive electrode active material layer according to an embodiment of the present invention.

FIG. 2 is a schematic sectional view of a lithium ion secondary battery according to the embodiment of the present invention.

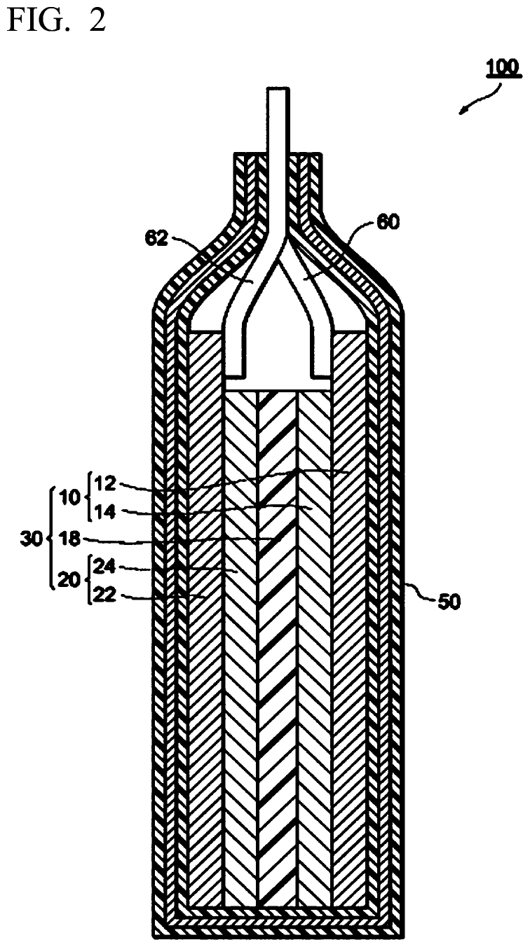

### DETAILED DESCRIPTION OF THE INVENTION

Hereinafter, preferred embodiments according to the present invention will be described with reference to the drawings. The present invention is not limited to the following embodiments. In addition, the configuration elements described below include those easily conceived by those skilled in the art and those substantially the same as those. Furthermore, the configuration elements described below can be combined as appropriate.

<Lithium Ion Secondary Battery>

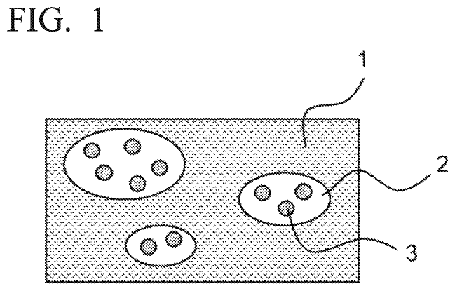

As illustrated in FIG. 1, a lithium ion secondary battery 100 according to the present embodiment includes: a laminate 30 including a plate-shaped negative electrode 20 and a plate-shaped positive electrode 10 facing each other, and a plate-shaped separator 18 disposed adjacently between the negative electrode 20 and the positive electrode 10; an electrolytic solution containing lithium ions; a case 50 that accommodates the laminate 30 and the electrolytic solution in a sealed state; a lead 62 of which one end portion is electrically connected to the negative electrode 20 and the other end portion protrudes outside of the case; and a lead 60 of which one end portion is electrically connected to the positive electrode 10 and the other end portion protrudes outside of the case.

The positive electrode 10 has a positive electrode current collector 12 and a positive electrode active material layer 14 formed on the positive electrode current collector 12. Further, the negative electrode 20 has a negative electrode current collector 22 and a negative electrode active material layer 24 formed on the negative electrode current collector 22. The separator 18 is positioned between the negative electrode active material layer 24 and the positive electrode active material layer 14.

<Positive Electrode>

According to the present embodiment, a positive electrode has a metal foil and a positive electrode active material layer provided on the metal foil, a plurality of voids are formed on the positive electrode active material layer, and a transition metal oxide having an average particle size of 10 nm or more and 500 nm or less is provided on an inner wall portion of the voids, on which the voids and the electrolytic solution are in contact with each other.

It is generally known that, when forming voids in the active material layer, the permeability with respect to the electrolytic solution is improved, and the diffusibility of lithium ions is improved. In addition, by supporting the nanoparticles of the transition metal oxide on the inner wall portion of the void, the wettability to the electrolytic solution is improved by the surface tension effect, and the affinity for the electrolytic solution is also improved by the large polarization of the transition metal oxide, and it becomes easier for the electrolytic solution to penetrate in the depth direction of the active material layer. As a result, the rate characteristics are improved.

Examples of a method for measuring the average particle size of the transition metal oxide include a method of observing a backscattered electron image of a positive electrode cross section with a scanning electron microscope (SEM). Since it is easy to detect the difference in atomic number in the backscattered electron image, it is possible to clearly distinguish the transition metal oxide on the inner wall portion of the void. Here, 100 transition metal oxide particles were observed, and the average thereof was defined as the average particle size.

As a method for producing such an electrode, for example, there is a method of using composite particles of a water-soluble compound and a transition metal oxide, but the method is not limited thereto, and any method can be used. First, the water-soluble compound and the transition metal oxide are complexed by any method such as a mechanochemical method. Using these composite particles, a slurry for producing a positive electrode active material is produced with an organic solvent, and a metal foil is coated with the slurry and dried. By washing the positive electrode obtained in this manner with water, the water-soluble compound is dissolved to form voids, and at the same time, the complexed transition metal oxide can be diffused and adhered to the inner wall portion of the voids.

Further, the positive electrode according to the present embodiment has preferably an average diameter of the voids of 1.0 μm or more and 10.0 μm or less.

Examples of a method for measuring the average diameter of the voids include a method of observing the cross section of the positive electrode with SEM. Here, 100 voids were observed, and the average thereof was defined as the average diameter of the voids.

When the void is extremely small, the permeability with respect to the electrolytic solution will not be improved, and when the void is extremely large, the capacity per unit area of the electrode will decrease, and the resistance will increase. When an average diameter is within the above-described range, it is suitable as the average diameter of the voids, and it is possible to improve the rate characteristics while maintaining other battery characteristics.

Further, the positive electrode according to the present embodiment has a significant improvement effect since the basis weight of the positive electrode active material layer increases. Specifically, the coating amount (basis weight) per unit area of the positive electrode active material layer is preferably 20 mg/cm² or more and 100 mg/cm² or less.

The positive electrode according to the present embodiment further preferably contains one or more transition metal oxides selected from Co, Mn, and Ni.

Further, at least a part of the transition metal oxide of the positive electrode according to the present embodiment is preferably coated with carbon nanotubes.

According to this, by coating the transition metal oxide with carbon nanotubes having a high aspect ratio and low conductivity, it is possible to suppress the conductive path disruption that tends to occur with the formation of voids, and it is possible to further improve the rate characteristics.

Such a positive electrode can be obtained by adding carbon nanotubes to produce composite particles in the process of producing composite particles from the water-soluble compound and the transition metal oxide.

The positive electrode according to the present embodiment may have the configurations illustrated below, if necessary.

(Positive Electrode Current Collector)

The positive electrode current collector 12 may be any conductive plate material, and for example, a thin metal plate (metal foil) such as aluminum or an alloy thereof or stainless steel can be used.

(Positive Electrode Active Material Layer)

The positive electrode active material layer 14 is mainly formed of a positive electrode active material, a positive electrode binder, and a positive electrode conductive auxiliary agent.

(Positive Electrode Active Material)

The positive electrode active material is not particularly limited as long as it is possible to reversibly carry out the absorption and desorption of lithium ions, the elimination and insertion (intercalation) of lithium ions, and the doping and dedoping of counter anions (for example, PF₆⁻) of lithium ions therewith, and a known electrode active material can be used. Examples thereof include lithium cobalt oxide (LiCoO₂), lithium nickel oxide (LiNiO₂), lithium manganese spinel (LiMn₂O₄), a composite metal oxide expressed by the general formula: LiNiₓCo_{y}Mn_{z}MaO₂ (x+y+z+a=1, 0≤x<1, 0≤y<1, 0≤z<1, 0≤a<1, where M is one or more kinds of elements selected from Al, Mg, Nb, Ti, Cu, Zn, and Cr), lithium vanadium compounds Liₐ(M)_{b}(PO₄)_{c} (where M=VO or V, 0.9≤a≤3.3, 0.9≤b≤2.2, 0.9≤c≤3.3), olivine-type LiM_{P}O₄ (where M represents one or more kinds of elements selected from Co, Ni, Mn, Fe, Mg, Nb, Ti, Al, and Zr), and other composite metal oxides such as lithium titanate (Li₄Ti₅O₁₂) and LiNiₓCo_{y}Al_{z}O₂ (0.9<x+y+z<1.1).

(Positive Electrode Binder)

The positive electrode binder binds the positive electrode active material to each other, and also binds the positive electrode active material layer 14 and the positive electrode current collector 12. The binder may be any binder as long as the binding is possible as described above, and for example, a fluororesin such as polyvinylidene fluoride (PVDF) or polytetrafluoroethylene (PTFE) can be used. However, from the viewpoint of utilizing the region where the carbon mapping and the oxygen mapping overlap in the cross-sectional SEM-EDS in the analysis, it is preferable that the positive electrode binder do not contain oxygen.

The content of the binder in the positive electrode active material layer 14 is not particularly limited, but when added, the content is preferably 0.5 to 5 parts by mass with respect to 100 parts by mass of the positive electrode active material.

(Positive Electrode Conductive Auxiliary Agent)

The positive electrode conductive auxiliary agent is not particularly limited as long as the conductivity of the positive electrode active material layer 14 is improved, and a known conductive auxiliary agent can be used. Examples thereof include carbon-based materials such as graphite and carbon black; metal fine powders such as copper, nickel, stainless steel, and iron; and conductive oxides such as ITO.

The content of the conductive auxiliary agent in the positive electrode active material layer 14 is not particularly limited, but when added, the content is preferably 0.5 to 5 parts by mass with respect to 100 parts by mass of the positive electrode active material.

<Negative Electrode>

(Negative Electrode Current Collector)

The negative electrode current collector 22 may be a conductive plate material, and for example, a thin metal plate (metal foil) such as copper can be used.

(Negative Electrode Active Material Layer)

The negative electrode active material layer 24 is mainly formed of a negative electrode active material, a negative electrode binder, and a negative electrode conductive auxiliary agent.

(Negative Electrode Active Material)

The negative electrode active material is not particularly limited as long as it is possible to reversibly carry out the absorption and desorption of lithium ions, or the elimination and insertion (intercalation) of lithium ions, and a known electrode active material can be used. Examples thereof include carbon-based materials such as graphite and hard carbon; silicon-based materials such as silicon oxide (SiOₓ) and metal silicon (Si); metal oxides such as lithium titanate (LTO); and metal materials such as lithium, tin, and zinc.

When no metal material is used as the negative electrode active material, the negative electrode active material layer 24 may further contain a negative electrode binder and a negative electrode conductive auxiliary agent.

(Negative Electrode Binder)

The negative electrode binder is not particularly limited, and the same binder as the positive electrode binder described above can be used.

(Negative Electrode Conductive Auxiliary Agent)

The negative electrode conductive auxiliary agent is not particularly limited, and the same conductive auxiliary agent as the positive electrode conductive auxiliary agent described above can be used.

<Electrolytic Solution>

The electrolytic solution according to the present invention is mainly formed of a solvent and an electrolyte.

(Solvent)

As the solvent, a solvent generally used for a lithium ion secondary battery can be mixed and used in an any ratio. Examples thereof include cyclic carbonate compounds such as ethylene carbonate (EC), propylene carbonate (PC), and butylene carbonate; chain carbonate compounds such as diethyl carbonate (DEC), ethylmethyl carbonate (EMC), and dimethyl carbonate (DMC); cyclic ester compounds such as γ-butyrolactone (GBL); and chain ester compounds such as propyl propionate (PrP), ethyl propionate (PrE), and ethyl acetate.

(Electrolyte)

The electrolyte is not particularly limited as long as the electrolyte is a lithium salt used as an electrolyte for a lithium ion secondary battery, and for example, an inorganic acid anion salt such as LiPF₆, LiBF₄, or lithium bis oxalate boron; and an organic acid anion salt such as LiCF₃SO₃, (CF₃SO₂)₂NLi, and (FSO₂)₂NLi can be used.

Although the preferred embodiment according to the present invention has been described above, the present invention is not limited to the above-described embodiment.

### EXAMPLE

Hereinafter, the present invention will be described in more detail based on Examples and Comparative Examples, but the present invention is not limited to the following Examples.

### Example 1

(Production of Composite Particles)

LiCl was used as the water-soluble compound, and Co₃O₄ having a particle size of 50 nm was used as the transition metal oxide. Using a planetary ball mill, 18 g of LiCl and 2 g of Co₃O₄, 0.1 g of single-wall carbon nanotubes (SWNT), and 20 g of ZrO₂ balls as crushing media were put into 100 cc pot, and complexation treatment was performed at a rotation speed of 400 rpm for 3 minutes to produce composite particles.

(Production of Positive Electrode)

LiCoO₂ was used as the positive electrode active material, carbon black was used as the conductive auxiliary agent, and PVDF was used as the binder. By mixing at a ratio of LiCoO₂:composite particles:carbon black:PVDF=85:5:5:5 (parts by mass) and dispersing this in N-methyl-2-pyrrolidone (NMP) using a hybrid mixer, the slurry for forming the positive electrode active material layer was prepared. An aluminum foil having a thickness of 20 μm was coated with this slurry such that the coating amount is 10.0 mg/cm², and dried at 100° C. to form a positive electrode active material layer. Furthermore, this was pressure-formed by a roller press machine. Then, the electrode was washed with an excess amount of pure water to completely dissolve LiCl in the composite particles, and a positive electrode in which voids were formed was produced.

(Production of Negative Electrode)

Natural graphite was used as the negative electrode active material, carbon black was used as the conductive auxiliary agent, and PVDF was used as the binder. By mixing at a ratio of natural graphite:carbon black:PVDF=80:10:10 (parts by mass) and dispersing this in N-methyl-2-pyrrolidone (NMP) using a hybrid mixer, the slurry for forming the negative electrode active material layer was adjusted. A copper foil having a thickness of 15 μm was coated with this slurry such that the coating amount is 8.0 mg/cm², and dried at 100° C. to form a negative electrode active material layer. Then, this was pressure-formed by a roller press machine to produce a negative electrode.

(Production of Electrolytic Solution)

Ethylene carbonate (EC) and diethyl carbonate (DEC) were used as the solvent, and lithium hexafluorophosphate (LiPF₆) was used as the supporting salt. Mixing was performed such that EC:DEC=50:50 (parts by volume), and LiPF₆ was dissolved into the mixture such that the concentration is 1.0 mol/L to produce an electrolytic solution.

(Production of Lithium Ion Secondary Battery for Evaluation)

The positive electrode and the negative electrode produced above were sequentially laminated via a polyethylene separator. The tab leads were ultrasonically welded to this laminate and then packaged in an aluminum laminate pack. Then, the electrolytic solution produced above was injected and vacuum-sealed to produce a lithium ion secondary battery for evaluation.

(Measurement of Rate Characteristics)

The lithium ion secondary battery for evaluation produced above was put into a thermostatic chamber set at 25° C. and evaluated by a charge/discharge test device manufactured by HOKUTO DENKO CORPORATION. First, charging was performed by constant current charging with a current value of 0.1 C until the battery voltage reaches 4.2 V, and then discharging was performed by constant current discharge with a current value of 0.1 C until the battery voltage reaches 3.0 V. The charging of the current value XC means a current value that can charge this battery in 1/X time.

Next, charging was performed by constant current charging with a current value of 0.1 C until the battery voltage reaches 4.2 V, and then discharging was performed by constant current discharge with a current value of 0.1 C until the battery voltage reaches 3.0 V. The discharge capacity at this time is A (Ah). Further, charging was performed by constant current charging with a current value of 0.1 C until the battery voltage reaches 4.2 V, and then discharging was performed by constant current discharge with a current value of 5.0 C until the battery voltage reaches 3.0 V. The discharge capacity at this time is B (Ah). 5C discharge retention rate (%)=B/A was defined, and the obtained values are illustrated in Table 1. The higher this value, the greater the rate characteristics.

### Example 2

A lithium ion secondary battery for evaluation of Example 2 was produced in the same manner as in Example 1 except that the particle size of the transition metal oxide was changed to the value illustrated in Table 1 in (Production of composite particles).

### Example 3

A lithium ion secondary battery for evaluation of Example 3 was produced in the same manner as in Example 1 except that the particle size of the transition metal oxide was changed to the value illustrated in Table 1 in (Production of composite particles).

### Example 4

In (Production of composite particles), the processing conditions in the planetary ball mill were set to 3 minutes at a rotation speed of 500 rpm to improve the crushing power and reduce the particle size of the composite particles. A lithium ion secondary battery for evaluation of Example 4 was produced in the same manner as in Example 4 except for the above.

### Example 5

In (Production of composite particles), the processing conditions in the planetary ball mill were set to 10 minutes at a rotation speed of 200 rpm to lower the rotation speed and promote the granulation of the composite particles. A lithium ion secondary battery for evaluation of Example 5 was produced in the same manner as in Example 1 except for the above.

### Example 6

In (Production of composite particles), the processing conditions in the planetary ball mill were set to 15 minutes at a rotation speed of 200 rpm to lower the rotation speed and promote the granulation of the composite particles. A lithium ion secondary battery for evaluation of Example 6 was produced in the same manner as in Example 1 except for the above.

### Example 7

A lithium ion secondary battery for evaluation of Example 7 was produced in the same manner as in Example 1 except that the used transition metal oxides were changed those illustrated in Table 1 in (Production of composite particles).

### Example 8

A lithium ion secondary battery for evaluation of Example 8 was produced in the same manner as in Example 1 except that the used transition metal oxides were changed those illustrated in Table 1 in (Production of composite particles).

### Example 9

A lithium ion secondary battery for evaluation of Example 9 was produced in the same manner as in Example 1 except that the used transition metal oxides were changed those illustrated in Table 1 in (Production of composite particles).

### Example 10

A lithium ion secondary battery for evaluation of Example 10 was produced in the same manner as in Example 1 except that the used transition metal oxides were changed those illustrated in Table 1 in (Production of composite particles).

### Example 11

A lithium ion secondary battery for evaluation of Example 11 was produced in the same manner as in Example 1 except that the used transition metal oxides were changed those illustrated in Table 1 in (Production of composite particles).

### Example 12

A lithium ion secondary battery for evaluation of Example 12 was produced in the same manner as in Example 1 except that the used transition metal oxides were changed those illustrated in Table 1 in (Production of composite particles).

### Example 13

A lithium ion secondary battery for evaluation of Example 13 was produced in the same manner as in Example 1 except that SWNT was not used in (Production of composite particles).

### Comparative Example 1

A lithium ion secondary battery for evaluation of Comparative Example 1 was produced in the same manner as in Example 1 except that Co₃O₄ was not used in (Production of composite particles).

### Comparative Example 2

A lithium ion secondary battery for evaluation of Comparative Example 2 was produced in the same manner as in Example 1 except that the particle size of the transition metal oxide was changed to the value illustrated in Table 1 in (Production of composite particles).

### Example 14

A lithium ion secondary battery for evaluation of Example 14 was produced in the same manner as in Example 1 except that the coating amount was 20.0 mg/cm² in (Production of positive electrode) and the coating amount was 16.0 mg/cm² in (Production of negative electrode).

### Comparative Example 3

A lithium ion secondary battery for evaluation of Comparative Example 3 was produced in the same manner as in Example 14 except that Co₃O₄ was not used in (Production of composite particles).

(Measurement of rate characteristics) was performed with respect to the lithium ion secondary batteries for evaluation produced in Examples 2 to 13 and Comparative Examples 1 and 2 in the same manner as in Example 1. The results are shown in Table

(Measurement of rate characteristics) was performed with respect to the lithium ion secondary batteries for evaluation produced in Example 14 and Comparative Example 3 in the same manner as in Example 1. The results are shown in Table 2.

In each of Examples 1 to 3, the rate characteristics were improved as compared with Comparative Example 1 in which the transition metal was not provided on the inner wall of the void. Further, by comparison with Comparative Example 2, it was clarified that the average particle size of the transition metal oxide is preferably 50 nm or more and 500 nm or less.

From the results of Examples 4 to 6, it was clarified that the average diameter of the voids is preferably 0.5 μm or more and 10.0 μm or less.

From the results of Examples 7 to 12, it was clarified that the rate characteristics were improved by using any of the transition metal oxides, but it was preferable to contain one or more transition metals selected from Co, Mn, and Ni.

From the results of Example 13, it was clarified that it was preferable that the transition metal oxide be coated with carbon nanotubes.

From the results of Example 14 and Comparative Example 3, it was clarified that the larger the coating amount per unit area, the greater the effect of improving the rate characteristics.

TABLE 1

| | Void | | Transition metal oxide | | 5 C |
|---|---|---|---|---|---|
| | Void | | | Particle | discharge |
| | diameter | CNT | | size | retention |
| | [μm] | coating | Compound | [nm] | rate |
| Example 1 | 1.0 | Present | Co₃O₄ | 50 | 78% |
| Example 2 | 1.0 | Present | Co₃O₄ | 10 | 79% |
| Example 3 | 1.0 | Present | Co₃O₄ | 500 | 76% |
| Example 4 | 0.8 | Present | Co₃O₄ | 50 | 68% |
| Example 5 | 10.0 | Present | Co₃O₄ | 50 | 77% |
| Example 6 | 12.0 | Present | Co₃O₄ | 50 | 70% |
| Example 7 | 1.0 | Present | CoO₂ | 50 | 78% |
| Example 8 | 1.0 | Present | MnO₂ | 50 | 76% |
| Example 9 | 1.0 | Present | Mn₃O₄ | 50 | 77% |
| Example 10 | 1.0 | Present | NiO₂ | 50 | 76% |
| Example 11 | 1.0 | Present | TiO₂ | 50 | 72% |
| Example 12 | 1.0 | Present | Al₂O₃ | 50 | 72% |
| Example 13 | 1.0 | Absent | Co₃O₄ | 50 | 75% |
| Comparative | 1.0 | Present | — | — | 51% |
| Example 1 | | | | | |
| Comparative | 1.0 | Present | Co₃O₄ | 600 | 57% |
| Example 2 | | | | | |

TABLE 2

| | Void | | Transition metal oxide | | 5 C |
|---|---|---|---|---|---|
| | Void | | | Particle | discharge |
| | diameter | CNT | | size | retention |
| | [μm] | coating | Compound | [nm] | rate |
| Example 14 | 1.0 | Present | Co₃O₄ | 50 | 68% |
| Comparative | 1.0 | Present | — | — | 27% |
| Example 3 | | | | | |

The present invention is to provide a lithium ion secondary battery having excellent rate characteristics.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Positive electrode active material layer
2 Void
3 Transition metal oxide
10 Positive electrode
12 Positive electrode current collector
14 Positive electrode active material layer
18 Separator
20 Negative electrode
22 Negative electrode current collector
24 Negative electrode active material layer
30 Laminate
50 Case
60, 62 Lead
100 Lithium ion secondary battery

What is claimed is:

1. A lithium ion secondary battery comprising:
a positive electrode;
a negative electrode;
a separator disposed between the positive electrode and the negative electrode; and
an electrolytic solution, wherein
the positive electrode has a metal foil and a positive electrode active material layer provided on the metal foil,
the positive electrode active material layer has a plurality of voids therein, and
a transition metal oxide having an average particle size of 10 nm or more and 500 nm or less is provided on an inner wall portion of the voids.

2. The lithium ion secondary battery according to claim 1, wherein
the average diameter of the voids is 0.5 μm or more and 10.0 μm or less.

3. The lithium ion secondary battery according to claim 1, wherein
the transition metal oxide contains one or more transition metals selected from Co, Mn, and Ni.

4. The lithium ion secondary battery according to claim 1, wherein
at least a part of the transition metal oxide is coated with carbon nanotubes.
